(19) United States
(12) Patent Application Publication
(10) Pub. No.: US 2017/0280689 A1
(43) Pub. Date: Oct. 5, 2017

(54) Modular Poultry Cage Door Assembly

(71) Applicant: Packaging Concepts & Design, LLC, Troy, MI (US)

(72) Inventor: Terry L. Fielder, Westland, MI (US)

(73) Assignee: Packaging Concepts & Design, LLC, Troy, MI (US)

(21) Appl. No.: 15/474,528

(22) Filed: Mar. 30, 2017

Related U.S. Application Data
(60) Provisional application No. 62/317,981, filed on Apr. 4, 2016.

(51) Int. Cl. A01K 31/02; E05F 1/10; A01K 31/00; E06B 3/34; A01K 31/18; E05C 9/10; E05C 5/02; E05D 3/02; A01K 45/00

(52) U.S. Cl. CPC A01K 31/02; E05D 3/02; E05F 1/1041; A01K 31/002; A01K 45/005; A01K 31/005; A01K 31/18; E05C 9/10; E05C 5/02; E06B 3/34

(57) ABSTRACT

A poultry cage door assembly includes a main body, a secondary body, and a bracket. The main body includes a main first lateral end extending from a main front side to a main rear side and from a main upper end to a main lower end. The main first lateral end includes a first keyed arrangement and a first bracket-receiving feature. The secondary body includes a secondary first lateral end extending from a secondary front side to a secondary rear side and from a secondary upper end to a secondary lower end. The secondary first lateral end includes a secondary keyed arrangement and a second bracket-receiving feature. The secondary keyed arrangement is configured to mate with the first keyed arrangement. The first bracket is mateable with the first bracket-receiving feature and the second bracket-receiving feature.

### CROSS REFERENCE TO RELATED APPLICATION

This application claims priority under 35 U.S.C. §119(e) to U.S. Provisional Patent Application No. 62/317,981, filed on Apr. 4, 2016. The disclosure of this prior application is considered part of the disclosure of this application and is hereby incorporated by reference in its entirety.

### FIELD

The present disclosure relates to a modular door and more particularly to a modular door assembly for a poultry cage.

### BACKGROUND

This section provides background information related to the present disclosure and is not necessarily prior art.

Cage assemblies are used to secure and transport various items, such as livestock and other animals. A cage assembly often includes a cage and a door movably supported by the cage. For example, the door may be hinged to the cage in order to allow the door to rotate between an open position, for removing the item from the cage, and a closed position, for securing the item within the cage. Often, the cage assembly may be used to secure and transport items having different sizes and/or various quantities of items having the same size. In this regard, a large cage assembly, having a large door, may be used to secure and transport a large item or a large quantity of items, and a small cage assembly, having a small door, may be used to secure and transport a small item or small quantity of items. If a door is damaged, it may be necessary to remove and replace it in order to continue using the cage assembly.

While known cage assemblies, including cage doors, have proven useful for their intended purpose, there remains a need for continuous improvement in the pertinent art.

### SUMMARY

This section provides a general summary of the disclosure, and is not a comprehensive disclosure of its full scope or all of its features.

One aspect of the disclosure provides a poultry cage door assembly. The poultry cage door assembly may include a main body, a secondary body, and a bracket. The main body may include a main front side, a main rear side opposite the main front side, a main upper end extending from the main front side to the main rear side, a main lower end opposite the main upper end and extending from the main front side to the main rear side, and a main first lateral end extending from the main front side to the main rear side and from the main upper end to the main lower end. The main first lateral end may include a first keyed arrangement and a first bracket-receiving feature. The secondary body may include a secondary front side, a secondary rear side opposite the secondary front side, a secondary upper end extending from the secondary front side to the secondary rear side, a secondary lower end opposite the secondary upper end and extending from the secondary front side to the secondary rear side, and a secondary first lateral end extending from the secondary front side to the secondary rear side and from the secondary upper end to the secondary lower end. The secondary first lateral end may include a secondary keyed arrangement and a second bracket-receiving feature. The secondary keyed arrangement may be configured to mate with the first keyed arrangement. The first bracket may be mateable with the first bracket-receiving feature and the second bracket-receiving feature.

Implementations of the disclosure may include one or more of the following optional features. In some implementations, the first keyed arrangement includes a first recess, a second recess, and a first flange. The second keyed arrangement may include a second flange, a third flange, and a third recess. The first recess may be configured to receive the second flange. The second recess may be configured to receive the third flange. The third recess may be configured to receive the first flange.

In some implementations, the poultry cage door assembly includes a reinforcement member. The main rear side may include a first channel and the secondary rear side may include a second channel. The first channel and the second channel may be configured to receive the reinforcement member.

In some implementations, the poultry cage door assembly includes a first fastener and a second fastener. The first fastener may be disposed within the reinforcement member and the main body. The second fastener may be disposed within the reinforcement member and the first secondary body.

In some implementations, the secondary first lateral end includes an axle and the main first lateral end includes an axle-receiving feature configured to receive the axle. The axle-receiving feature and the axle may collectively define an axis of rotation of the door assembly.

In some implementations, the axle-receiving feature includes a hub.

In some implementations, the main lower end and the secondary lower end collectively define an axis of rotation.

In some implementations, the poultry cage door assembly includes a first fastener disposed within the main body and the first secondary body.

In some implementations, the poultry cage door assembly includes a second secondary body having a second secondary lateral end including a secondary keyed arrangement. The main body may include a main second lateral end opposite the main first lateral end. The main second lateral end may include a third keyed arrangement configured to mate with the secondary keyed arrangement of the second secondary lateral end.

In some implementations, the poultry cage door assembly includes a second bracket. The second secondary lateral end of the second secondary body may include a third bracket-receiving feature configured to receive the second bracket.

Another aspect of the disclosure provides a poultry cage door assembly. The poultry cage door assembly may include a main body, a secondary body, and a bracket. The main body may extend from a first end to a second end opposite the first end. The first end may include a first keyed arrangement and a first bracket-receiving feature. The second end may include a second keyed arrangement. The secondary body may include a third keyed arrangement and a second bracket-receiving feature. The third keyed arrangement may be configured to mate with one of the first keyed arrangement and the second keyed arrangement. The first bracket may be mateable with the first bracket-receiving feature and the second bracket-receiving feature.

This aspect may include one or more of the following optional features. In some implementations, the first keyed arrangement includes a first recess, a second recess, and a first flange. The second keyed arrangement may include a second flange, a third flange, and a third recess. The first recess may be configured to receive the second flange. The second recess may be configured to receive the third flange. The third recess may be configured to receive the first flange.

In some implementations, the poultry cage door assembly includes a reinforcement member. The body may include a first channel. The first secondary body may include a second channel. The first channel and the second channel may be configured to receive the reinforcement member.

In some implementations, the poultry cage door assembly includes a first fastener and a second fastener. The first fastener may be disposed within the reinforcement member and the main body. The second fastener may be disposed within the reinforcement member and the first secondary body.

In some implementations, the secondary body includes an axle. The main body may include an axle-receiving feature configured to receive the axle. The axle-receiving feature and the axle may collectively defining an axis of rotation of the door assembly.

In some implementations, the axle-receiving feature includes a hub.

In some implementations, the main body and the secondary body collectively define an axis of rotation.

In some implementations, the poultry cage door assembly includes a first fastener disposed within the main body and the first secondary body.

In some implementations, the poultry cage door assembly includes a second secondary body having a fourth keyed arrangement configured to mate with one of the first keyed arrangement and the second keyed arrangement.

In some implementations, the poultry cage door assembly includes a second bracket. The second secondary body may further include a third bracket-receiving feature configured to receive the second bracket.

The details of one or more implementations of the disclosure are set forth in the accompanying drawings and the description below. Other aspects, features, and advantages will be apparent from the description and drawings, and from the claims.

### DRAWINGS

The drawings described herein are for illustrative purposes only of selected configurations and are not intended to limit the scope of the present disclosure.

FIG. 1 is a perspective view of a plurality of cage assemblies in accordance with the principles of the present disclosure;

FIG. 2A is a perspective view of a cage assembly of the plurality of cage assemblies of FIG. 1, including a cage door in a first mode of operation in accordance with the principles of the present disclosure;

FIG. 2B is a perspective view of the cage assembly of FIG. 2A, including the cage door in a second mode of operation in accordance with the principles of the present disclosure;

FIG. 2C is a perspective view of another cage assembly of the plurality of cage assemblies of FIG. 1, including a cage door in the first mode of operation in accordance with the principles of the present disclosure; and

FIG. 3 is an exploded view of the cage door of FIG. 2A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

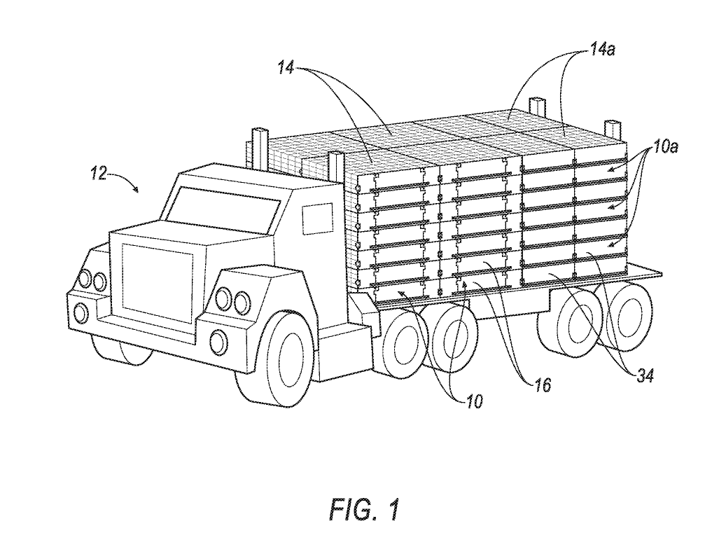

With reference to FIG. 1, a cage assembly 10 is provided. As illustrated, in some implementations, a plurality of cage assemblies 10 may be stacked and/or arranged in columns and/or rows on a vehicle 12 or other transportation device (e.g., a trailer, a train, a boat, etc.) in order to transport an item from an origin to a destination. In this regard, in some implementations, the cage assembly 10 is configured to hold and/or transport livestock, such as poultry. It will be appreciated, however, that the cage assembly 10 may be used for holding and/or transporting other items within the scope of the present disclosure.

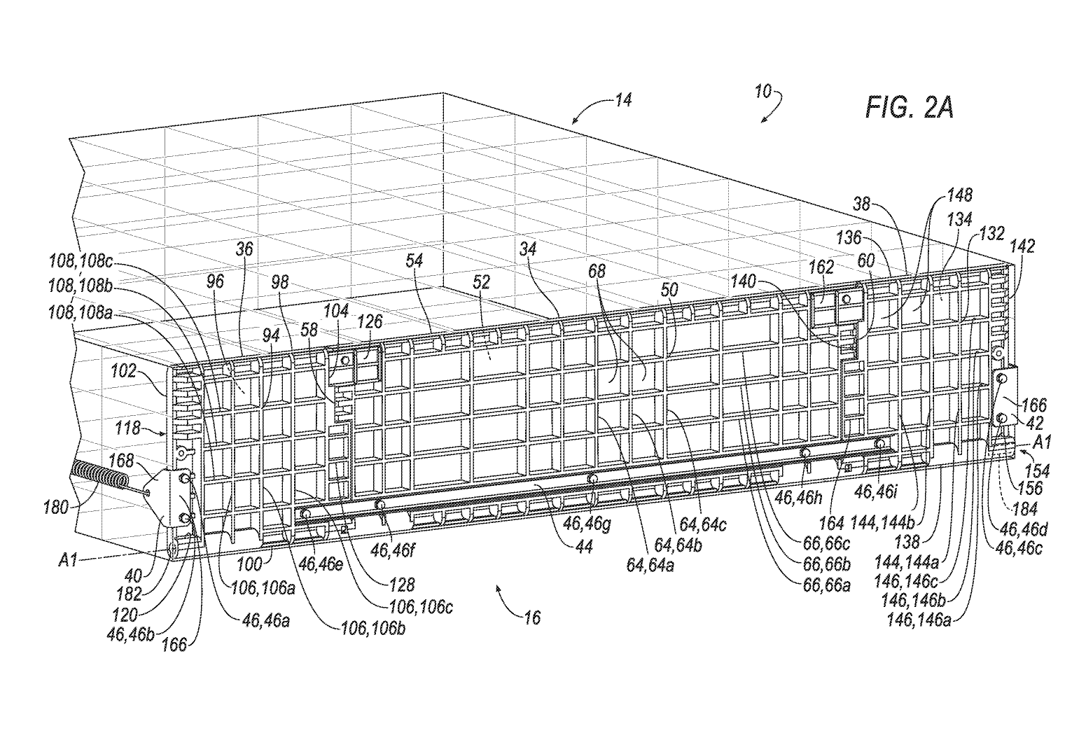

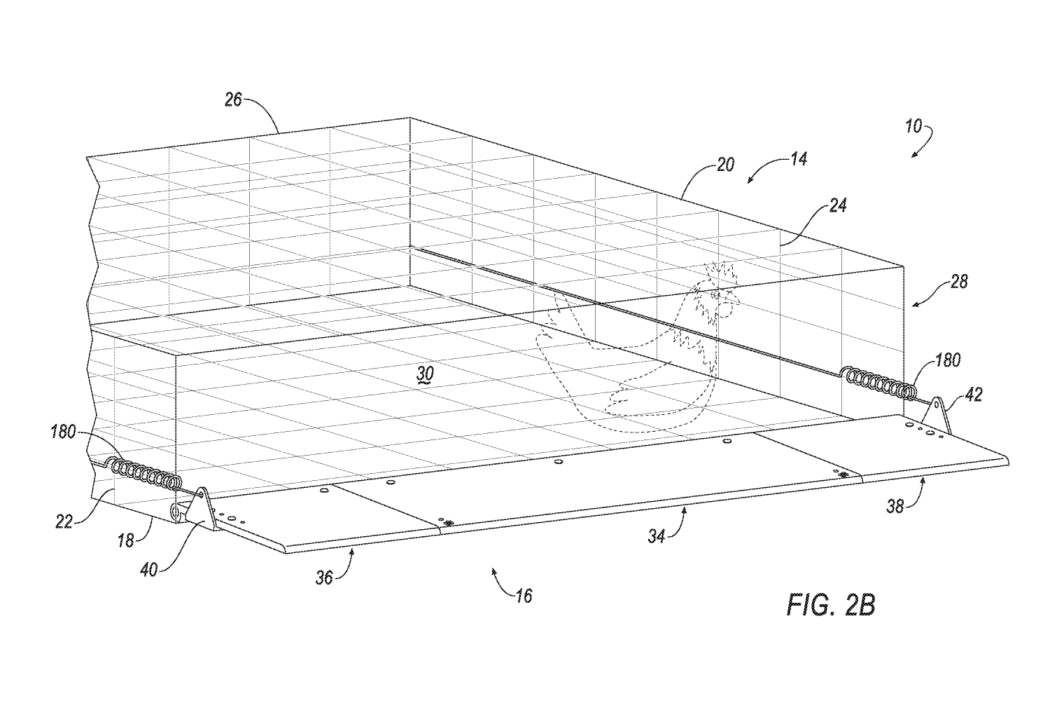

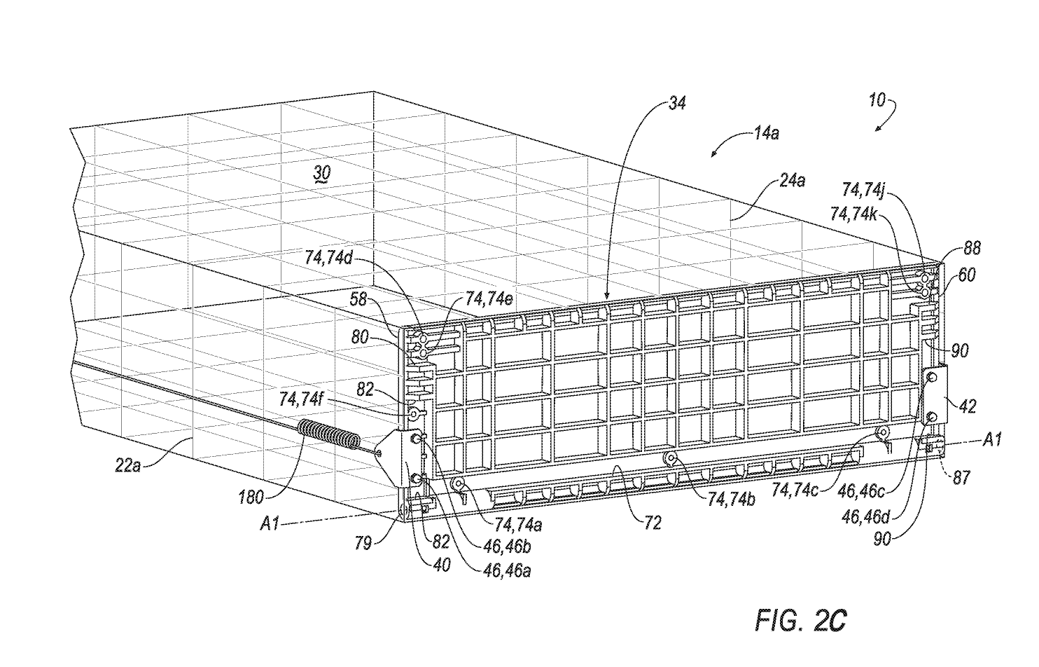

With reference to FIG. 2A, the cage assembly 10 may include a cage 14 and a door subassembly 16. The cage 14 may include a bottom wall 18, a top wall 20 opposite the bottom wall 18, a lateral side wall 22 extending from the top wall 20 to the bottom wall 18, a medial side wall 24 opposite the lateral side wall 22 and extending from the top wall 20 to the bottom wall 18, a rear wall 26 extending from the top wall 20 to the bottom wall 18 and from the medial side wall 24 to the lateral side wall 22, and an opening 28 (FIG. 2B) opposite the rear wall 26 and defined by the bottom wall 18, the top wall 20, the lateral side wall 22, and the medial side wall 24. As illustrated in FIG. 2A, in some implementations the bottom wall 18, the top wall 20, the lateral side wall 22, the medial side wall 24, and the rear wall 26 collectively define a rectangular cuboid having a chamber 30 in communication with the opening 28.

The door subassembly 16 may be movably coupled to the cage 14. For example, in some implementations, the door subassembly 16 is rotatably coupled to the cage 14 for rotation about an axis of rotation A1 between a closed position (FIGS. 1, 2A, and 2C) and an open position (FIG. 2B). In this regard, in the closed position, the door subassembly 16 may substantially cover the opening 28 in order to secure the contents (e.g., poultry) of the cage assembly 10 within the chamber 30. As illustrated in FIG. 2A, in some implementations, the door subassembly 16 is rotatably coupled to at least one of the bottom wall 18, the lateral side wall 22, and the medial side wall 24, such that the axis of rotation A1 extends through, or is otherwise defined by, the door subassembly 16 and at least one of the bottom wall 18, the lateral side wall 22, and the medial side wall 24.

With reference to FIGS. 2A-2B, in some implementations, the door subassembly 16 may include a modular construction, including a main body 34, a lateral secondary body 36, a medial secondary body 38, a lateral bracket 40, a medial bracket 42, a reinforcement member 44, and a plurality of fasteners 46, 46a-n (e.g., bolts, screws, rivets, nails, or any other suitable form of a removable mechanical fastener.). In some implementations, the main body 34, the lateral secondary body 36, and/or the medial secondary body 38 are formed from a polymer. In this regard, the main body 34, the lateral secondary body 36, and/or the medial secondary body 38 may be formed by an injection molding process. It will be appreciated, however, that the main body 34, the lateral secondary body 36, and/or the medial secondary body 38 may be formed from other materials (e.g., metal, fiberglass, wood, etc.) and methods within the scope of the present disclosure.

As will be explained in more detail below, in some implementations the door subassembly 16 is formed or otherwise assembled without at least one of the lateral secondary body 36, the medial secondary body 38, the lateral bracket 40, the medial bracket 42, the reinforcement member 44, and/or one or more of the plurality of fasteners 46, 46a-n. In particular, in some implementations, the door subassembly 16 may include the main body 34, the lateral bracket 40, the medial bracket 42, and one or more of the plurality of fasteners 46, 46a-n. In this regard, another configuration of a cage assembly 10a is illustrated in FIG. 2C. The cage assembly 10a may be substantially similar to the cage assembly 10, except as otherwise provided herein. For example, the cage assembly 10a may define a first distance (e.g., a width of the cage 14a) extending from a lateral side wall 22a to a medial side wall 24a, and the cage assembly 10 may define a second distance (e.g., a width of the cage 14) extending from the lateral side wall 22 to the medial side wall 24. The second distance may be greater than the first distance.

The main body 34 may include a main front side 50, a main rear side 52, a main upper end 54, a main lower end 56, a main lateral end 58, and a main medial end 60. The main rear side 52 may be opposite the main front side 50. The main upper end 54 may extend from the main front side 50 to the main rear side 52. The main lower end 56 may be opposite the main upper end 54 and may extend from the main front side 50 to the main rear side 52. The main lateral end 58 may extend from the main front side 50 to the main rear side 52 and from the main upper end 54 to the main lower end 56. As illustrated, in some implementations, the main upper end 54, lower end 56, lateral end 58, and medial end 60 may collectively define a substantially rectangular shape. It will be appreciated, however, that the main upper end 54, lower end 56, lateral end 58, and medial end 60 may collectively define other shapes within the scope of the present disclosure.

The main body 34 may include a grid-like arrangement extending from and between the main front side 50 and the main rear side 52. In this regard, the main body 34 may include a plurality of longitudinally-extending beams 64, 64a-n extending from the main upper end 54 to the main lower end 56, and a plurality of laterally-extending beams 66, 66a-n extending from the main lateral end 58 to the main medial end 60. The longitudinally-extending beams 64, 64a-n and the laterally-extending beams 66, 66a-n may define a plurality of windows 68 (e.g., apertures) extending through the main front side 50 and the main rear side 52. In some implementations, the longitudinally-extending beams 64, 64a-n extend in a direction substantially perpendicular (e.g., +/−5 degrees) to the main upper end 54, the main lower end 56, and/or the laterally-extending beams 66, 66a-n, and the laterally-extending beams 66, 66a-n extend in a direction substantially perpendicular (e.g., +/−5 degrees) to the main lateral end 58, the main medial end 60, and/or the longitudinally-extending beams 64, 64a-n. Accordingly, the longitudinally-extending beams 64, 64a-n, the laterally-extending beams 66, 66a-n, the main upper end 54, the main lower end 56, the main lateral end 58, and/or the main medial end 60 may define a plurality of rectangular-shaped windows 68.

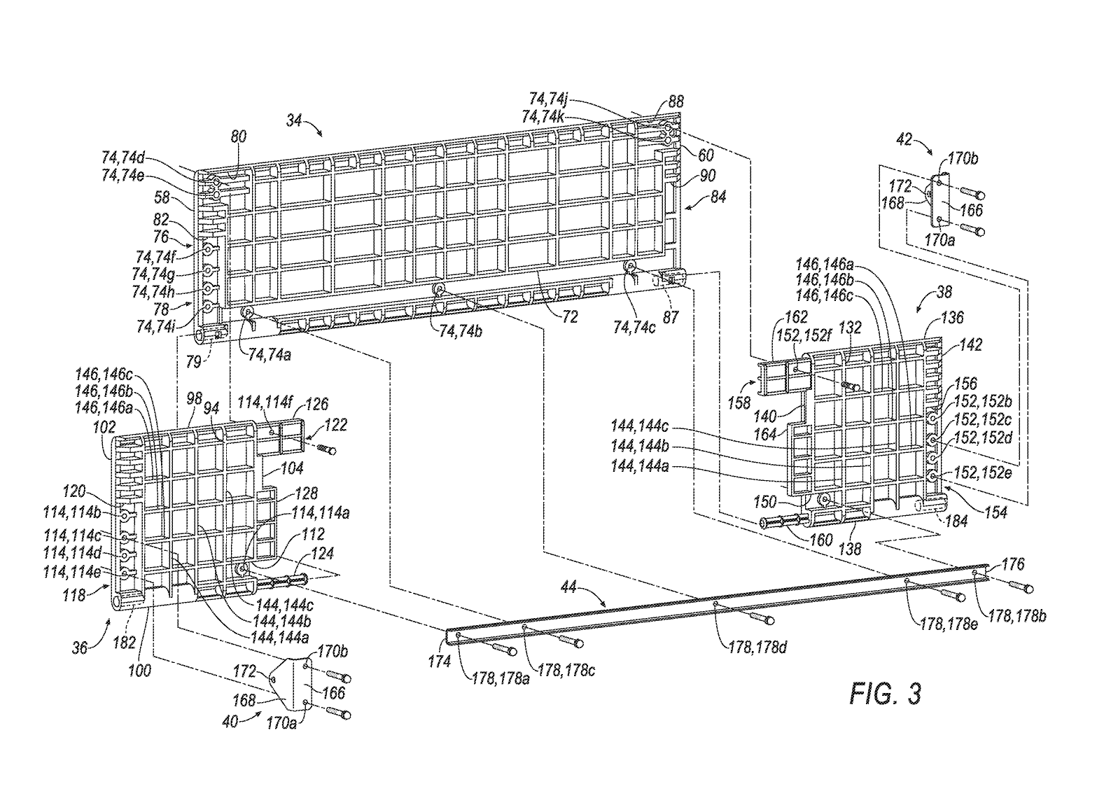

As illustrated in FIG. 3, one of the main front side 50 and the main rear side 52 may include a laterally-extending channel 72 and one or more fastener-receiving features 74, 74a-n (e.g., apertures). For example, in some implementations, the main front side 50 includes the channel 72. The channel 72 may extend from the main lateral end 58 to the main medial end 60. The fastener-receiving features 74, 74a-n may extend through one or both of the main front side 50 and the main rear side 52. In this regard, the fastener-receiving features 74, 74a-n may be integrally and monolithically formed with one of the longitudinally-extending beams 64, 64a-n and the laterally-extending beams 66, 66a-n. As illustrated in FIG. 3, in some implementations, the main front side 50 includes three equally-spaced fastener-receiving features 74a, 74b, 74c aligned with, and disposed within, the channel 72.

The main lateral end 58 may include a first keyed arrangement 76, a first bracket-receiving feature 78, and a first rotation feature 79. The first keyed arrangement 76 may include a first recess 80 and a second recess 82. The first and second recesses 80, 82 may be formed in the main lateral end 58 and one of the main front side 50 and the main rear side 52. For example, in some implementations, the first and second recesses 80, 82 are formed in the main lateral end 58 and the main front side 50. The first recess 80 may be disposed proximate to the main upper end 54. The second recess 82 may be disposed proximate to the main lower end 56. In this regard, the second recess 82 may be in communication with the channel 72.

Two fastener-receiving features 74d, 74e may be aligned with, and disposed within, the first recess 80, and four fastener-receiving features 74f, 74g, 74h, 74i may be aligned with, and disposed within, the second recess 82. The first bracket-receiving feature 78 may correspond to, and be aligned with, the second recess 82. In this regard, as will be explained in more detail below, the second recess 80 may be sized and shaped to (i) receive a portion of the lateral secondary body 36 in a first mode of operation and (ii) receive the lateral bracket 40 in a second mode of operation. The first rotation feature 79 may include a hub (e.g., an aperture) formed in the main lateral end 58 proximate the main lower end 56.

The main medial end 60 may include a second keyed arrangement 84 and a second rotation feature 87. The second keyed arrangement 76 may include a first recess 88 and a second recess 90. The first and second recesses 88, 90 may be formed in the main medial end 60 and one of the main front side 50 and the main rear side 52. For example, in some implementations, the first and second recesses 88, 90 are formed in the main medial end 60 and the main front side 50. The first recess 88 may be disposed proximate to the main upper end 54. The second recess 90 may be disposed proximate to the main lower end 56. In this regard, the second recess 90 may be in communication with the channel 72.

Two fastener-receiving features 74j, 74k may be aligned with, and disposed within, the first recess 88. As will be explained in more detail below, the second recess 90 may be sized and shaped to receive a portion of the medial secondary body 38 in a first mode of operation. The second rotation feature 87 may include a hub (e.g., an aperture) formed in the main medial end 60 proximate the main lower end 56. In this regard, the second rotation feature 87 may be aligned with the first rotation feature 79 relative to the main lower end 56.

The lateral secondary body 36 may include a front side 94, a rear side 96, an upper end 98, a lower end 100, a lateral end 102, and a medial end 104. The rear side 96 may be opposite the front side 94. The upper end 98 may extend from the front side 94 to the rear side 96. The lower end 100 may be opposite the upper end 98 and may extend from the front side 94 to the rear side 96. The lateral end 102 may extend from the front side 94 to the rear side 96 and from the upper end 98 to the lower end 100. As illustrated, in some implementations, the upper end 98, lower end 100, lateral end 102, and medial end 104 may collectively define a substantially rectangular shape. It will be appreciated, however, that the upper end 98, lower end 100, lateral end 102, and medial end 104 may collectively define other shapes within the scope of the present disclosure.

The lateral secondary body 36 may include a grid-like arrangement extending from and between the front side 94 and the rear side 96. In this regard, the lateral secondary body 36 may include a plurality of longitudinally-extending beams 106, 106a-n extending from the upper end 98 to the lower end 100, and a plurality of laterally-extending beams 108, 108a-n extending from the lateral end 102 to the medial end 104. The longitudinally-extending beams 106, 106a-n and the laterally-extending beams 108, 108a-n may define a plurality of windows 110 (e.g., apertures) extending through the front side 94 and the rear side 96. In some implementations, the longitudinally-extending beams 106, 106a-n extend in a direction substantially perpendicular (e.g., +/−5 degrees) to the upper end 98, the lower end 100, and/or the laterally-extending beams 108, 108a-n, and the laterally-extending beams 108, 108a-n extend in a direction substantially perpendicular (e.g., +/−5 degrees) to the lateral end 102, the medial end 104, and/or the longitudinally-extending beams 106, 106a-n. Accordingly, the longitudinally-extending beams 106, 106a-n, the laterally-extending beams 108, 108a-n, the upper end 98, the lower end 100, the lateral end 102, and/or the medial end 104 may define a plurality of rectangular-shaped windows 110.

One of the front side 94 and the rear side 96 may include a laterally-extending channel 112 and one or more fastener-receiving features 114, 114a-n (e.g., apertures). For example, as illustrated in FIG. 3, in some implementations, the front side 94 includes the channel 112. The channel 112 may extend from and into the medial end 104. The fastener-receiving features 114, 114a-n may extend through one or both of the front side 94 and the rear side 96. In this regard, the fastener-receiving features 114, 114a-n may be integrally and monolithically formed with one of the longitudinally-extending beams 106, 106a-n and the laterally-extending beams 108, 108a-n. As illustrated in FIG. 3, in some implementations, the rear side 96 includes a fastener-receiving feature 114a aligned with, and disposed within, the channel 112.

The lateral end 102 of the lateral secondary body 36 may include a bracket-receiving feature 118. The bracket-receiving feature 118 may include a recess 120 sized and shaped to receive the lateral bracket 40 in the first mode of operation. In some implementations, four fastener-receiving features 114b, 114c, 114d, 114e may be aligned with, and disposed within, the recess 120.

The medial end 104 of the lateral secondary body 36 may include a keyed arrangement 122 and a rotation feature 124. The keyed arrangement 122 may include a first key 126 and a second key 128. The first and second keys 126, 128 may extend from the medial end 104 of the lateral secondary body 36. The first key 126 may be disposed proximate to the upper end 98. The second key 128 may be disposed proximate to the lower end 100. One fastener-receiving feature 114f may be aligned with, and disposed within, the first key 126. The rotation feature 124 may include an axle (e.g., a cylindrical post) extending from the medial end 104 of the lateral secondary body 36 proximate the lower end 100.

The medial secondary body 38 may include a front side 132, a rear side 134, an upper end 136, a lower end 138, a lateral end 140, and a medial end 142. The rear side 134 may be opposite the front side 132. The upper end 136 may extend from the front side 132 to the rear side 134. The lower end 138 may be opposite the upper end 136 and may extend from the front side 132 to the rear side 134. The lateral end 140 may extend from the front side 132 to the rear side 134 and from the upper end 136 to the lower end 138. As illustrated, in some implementations, the upper end 136, lower end 138, lateral end 140, and medial end 142 may collectively define a substantially rectangular shape. It will be appreciated, however, that the upper end 136, lower end 138, lateral end 140, and medial end 142 may collectively define other shapes within the scope of the present disclosure.

The medial secondary body 38 may include a grid-like arrangement extending from and between the front side 132 and the rear side 134. In this regard, the medial secondary body 38 may include a plurality of longitudinally-extending beams 144, 144a-n extending from the upper end 136 to the lower end 138, and a plurality of laterally-extending beams 146, 146a-n extending from the lateral end 140 to the medial end 142. The longitudinally-extending beams 144, 144a-n and the laterally-extending beams 146, 146a-n may define a plurality of windows 148 (e.g., apertures) extending through the front side 132 and the rear side 134. In some implementations, the longitudinally-extending beams 144, 144a-n extend in a direction substantially perpendicular (e.g., +/−5 degrees) to the upper end 136, the lower end 138, and/or the laterally-extending beams 146, 146a-n, and the laterally-extending beams 146, 146a-n extend in a direction substantially perpendicular (e.g., +/−5 degrees) to the lateral end 140, the medial end 142, and/or the longitudinally-extending beams 144, 144a-n. Accordingly, the longitudinally-extending beams 144, 144a-n, the laterally-extending beams 146, 146a-n, the upper end 136, the lower end 138, the lateral end 140, and/or the medial end 142 may define a plurality of rectangular-shaped windows 148.

One of the front side 132 and the rear side 134 may include a laterally-extending channel 150 and one or more fastener-receiving features 152, 152a-n (e.g., apertures). For example, as illustrated in FIG. 3, in some implementations, the front side 132 includes the channel 150. The channel 150 may extend from and into the lateral end 140. The fastener-receiving features 152, 152a-n may extend through one or both of the front side 132 and the rear side 134. In this regard, the fastener-receiving features 152, 152a-n may be integrally and monolithically formed with one of the longitudinally-extending beams 144, 144a-n and the laterally-extending beams 146, 146a-n. As illustrated in FIG. 3, in some implementations, the rear side 134 includes a fastener-receiving feature 152a aligned with, and disposed within, the channel 150.

The medial end 142 of the medial secondary body 38 may include a bracket-receiving feature 154. The bracket-receiving feature 154 may include a recess 156 sized and shaped to receive the medial bracket 42 in the first mode of operation. In some implementations, four fastener-receiving features 152b, 152c, 152d, 152e may be aligned with, and disposed within, the recess 156.

The lateral end 140 of the medial secondary body 38 may include a keyed arrangement 158 and a rotation feature 160. The keyed arrangement 158 may include a first key 162 and a second key 164. The first and second keys 162, 164 may extend from the lateral end 140 of the medial secondary body 38. The first key 162 may be disposed proximate to the upper end 136. The second key 128 may be disposed proximate to the lower end 138. One fastener-receiving feature 152f may be aligned with, and disposed within, the first key 162. The rotation feature 160 may include an axle (e.g., a cylindrical post) extending from the lateral end 140 of the medial secondary body 38 proximate the lower end 138.

With reference to FIG. 3, the lateral bracket 40 may be substantially identical to the medial bracket 42. Accordingly, references herein to the bracket 40, 42 will be understood to apply equally to the lateral bracket 40 and the medial bracket 42, except as otherwise provided herein. The bracket 40, 42 may define a substantially L-shaped construct, including a base portion 166 and a beam portion 168 extending transversely from the base portion 166. For example, the beam portion 168 may extend substantially perpendicularly (+/−5 degrees) from the base portion 166. The base portion 168 may include a first fastener-receiving feature 170a (e.g., an aperture) and a second fastener-receiving feature 170b (e.g., an aperture). The beam portion 168 may include an aperture 172.

The reinforcement member 44 may define a substantially U-shaped construct extending from a proximal end 174 to a distal end 176. The reinforcement member 44 may include a plurality of fastener-receiving features 178, 178a-n. For example, in some implementations, the reinforcement member 44 may include a first fastener-receiving feature 178a dispose proximate the proximal end 174, a second fastener-receiving feature 178b disposed proximate the distal end 176, and three fastener-receiving features 178c, 178d, 178e disposed between the proximal end 174 and the distal end 176. As will be explained in more detail below, in an assembled configuration, the reinforcement member 44 may be coupled to the main body 34, the lateral secondary body 36, and the medial secondary body 38 in order to help secure the main body 34 to the lateral secondary body 36 and to the medial secondary body 38, and to provide strength to the assembled main body 34, lateral secondary body 36, and medial secondary body 38.

With reference to FIGS. 2A-2C, methods of using and/or assembling the cage assembly 10 will now be described. As illustrated in FIG. 2C, in a first mode of operation, the lateral bracket 40 may be coupled to main body 34. For example, the lateral bracket 40 may be coupled to the lateral end 58 of the main body 34. In some implementations first and second fasteners 46a, 46b of the plurality of fasteners 46, 46a-n extend through the first and second fastener-receiving features 170a, 170b of the lateral bracket 40 and into the fastener-receiving features 74f, 74g of the main body 34. In this regard, in the first mode of operation, the base portion 168 of the lateral bracket 40 may be disposed within first bracket-receiving feature 78.

In the first mode of operation, the main body 34 may be coupled to the cage 14 such that the axis of rotation A1 extends through the first rotation feature 79 and the second rotation feature 87. In this regard, a portion (e.g., a post, axle, pin, or other similar construct) of the cage 14 may be disposed within, or otherwise coupled to, the first rotation feature 79 and the second rotation feature 87 in order to allow the main body 34 to rotate relative to the cage 14. A closing mechanism 180 (e.g., a biasing member, such as a spring) may be coupled to the beam portion 168 (e.g., aperture 172) and to the cage 12 in order to bias the door subassembly 14 (e.g., the main body 34) into a closed position relative to the cage 12.

With reference to FIG. 2A-2B, in a second mode of operation, the lateral secondary body 36 may be coupled to the lateral end 58 of the main body 34 and the medial secondary body 38 may be coupled to the medial end 60 of the main body 34. In this regard, in the second mode of operation, the first keyed arrangement 76 of the main body 34 may mate with the keyed arrangement 122 of the lateral secondary body 36, and the second keyed arrangement 84 of the main body 34 may mate with the keyed arrangement 158 of the medial secondary body 38. In particular, (i) the first key 126 of the lateral secondary body 36 may be disposed within the first recess 80 of the main body 34, (ii) the second key 128 of the lateral secondary body 36 may be disposed within the second recess 82 of the main body 34, (iii) the first key 162 of the medial secondary body 38 may be disposed within the first recess 88 of the main body 34, and (iv) the second key 164 of the medial secondary body 38 may be disposed within the second recess 90 of the main body 34.

In the second mode of operation, the rotation feature 124 of the lateral secondary body 36 may be disposed within, or otherwise coupled to, the first rotation feature 79 of the main body 34, and the rotation feature 160 of the medial secondary body 38 may be disposed within, or otherwise coupled to, the second rotation feature 87 of the main body 34. The reinforcement member 44 may be disposed within the channel 72 of the main body 34, the channel 112 of the lateral secondary body 36, and the channel 150 of the medial secondary body 38. A fifth fastener 46e may extend through the fastener-receiving feature 178a of the reinforcement member 44 and into the fastener-receiving feature 114a of the lateral secondary body 36. Sixth, seventh, and eighth fastener 46f, 46g, 46h may extend through the fastener-receiving features 178c, 178d, 178e of the reinforcement member 44 and into the fastener-receiving features 74a, 74b, 74c of the main body 34. A ninth fastener 46i may extend through the fastener-receiving feature 178b of the reinforcement member 44 and into the fastener-receiving feature 152a of the medial secondary body 38.

In the second mode of operation, the lateral bracket 40 may be coupled to the lateral end 102 of the lateral secondary body 36 and the medial bracket 42 may be coupled to the medial end 142 of the medial secondary bracket 38. For example, the lateral bracket 40 may be disposed within the bracket-receiving feature 118 of the lateral secondary bracket 36, and the medial bracket may be disposed within the bracket-receiving feature 154 of the medial secondary bracket 38.

The first and second fasteners 46a, 46b may extend through the first and second fastener-receiving features 170a, 170b of the lateral bracket 40 and into the fastener-receiving features 114b, 114c of the lateral secondary body 36. Third and fourth fasteners 46c, 46d may extend through the first and second fastener-receiving features 170a, 170b of the medial bracket 42 and into the fastener-receiving features 152b, 152c of the medial secondary bracket 38. A portion (e.g., a post, axle, pin, or other similar construct) of the cage 14 may be disposed within, or otherwise coupled to, (i) a rotation feature 182 disposed in the lateral end 102 of the lateral secondary body 36 and (ii) a rotation feature 184 disposed in the medial end 142 of the medial secondary body 38 in order to allow the door subassembly 14 to rotate relative to the cage 14. The closing mechanism 180 may be coupled to the beam portion 168 and to the cage 12 in order to bias the door subassembly 14 into a closed position relative to the cage 12.

The configuration of the door subassembly 16, including the configuration of the main body 34, the lateral secondary body 36, and the medial secondary body 38, allows a user to change the size (e.g., the length) of the door subassembly 16, and thus allows the user to use the door subassembly 16 on cages 12 having variously-sized openings 28. For example, in the first mode of operation, the user may utilize the door subassembly 16 (e.g., the main body 34) on a cage 12 having an opening 28 defining a first length. In the second mode of operation, the user may utilize the door subassembly 16 (e.g., the main body 34, the lateral secondary body 36, and/or the medial secondary body 38) on a cage 12 having an opening 28 defining a second length that is greater than the first length. Accordingly, the modularity of the door subassembly 16 can allow the user to utilize the door subassembly 16 with, and couple the door subassembly 16 to, a variety of cages 12. The configuration of the door subassembly 16 may be particularly well-suited for cages adapted to secure and transport poultry, such as chickens. In particular, because such cages include a variety of sizes having variously-sized openings 28, the door subassembly 16 allows a user to utilize variations of the same door subassembly 16 to close and/or cover each of the variously-sized openings 28.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A poultry cage door assembly comprising:
a main body including a main front side, a main rear side opposite the main front side, a main upper end extending from the main front side to the main rear side, a main lower end opposite the main upper end and extending from the main front side to the main rear side, a main first lateral end extending from the main front side to the main rear side and from the main upper end to the main lower end, the main first lateral end including a first keyed arrangement and a first bracket-receiving feature;
a first secondary body including a secondary front side, a secondary rear side opposite the secondary front side, a secondary upper end extending from the secondary front side to the secondary rear side, a secondary lower end opposite the secondary upper end and extending from the secondary front side to the secondary rear side, a secondary first lateral end extending from the secondary front side to the secondary rear side and from the secondary upper end to the secondary lower end, the secondary first lateral end including a secondary keyed arrangement and a second bracket-receiving feature, the secondary keyed arrangement configured to mate with the first keyed arrangement; and
a first bracket mateable with the first bracket-receiving feature and the second bracket-receiving feature.

2. The poultry cage door assembly of claim 1, wherein the first keyed arrangement includes a first recess, a second recess, and a first flange, wherein the second keyed arrangement includes a second flange, a third flange, and a third recess, the first recess configured to receive the second flange, the second recess configured to receive the third flange, and the third recess configured to receive the first flange.

3. The poultry cage door assembly of claim 1, further comprising a reinforcement member, the main rear side including a first channel and the secondary rear side including a second channel, the first channel and the second channel configured to receive the reinforcement member.

4. The poultry cage door assembly of claim 3, further comprising a first fastener and a second fastener, the first fastener disposed within the reinforcement member and the main body, the second fastener disposed within the reinforcement member and the first secondary body.

5. The poultry cage door assembly of claim 1, wherein the secondary first lateral end includes an axle, the main first lateral end includes an axle-receiving feature configured to receive the axle, the axle-receiving feature and the axle collectively defining an axis of rotation of the door assembly.

6. The poultry cage door assembly of claim 5, wherein the axle-receiving feature includes a hub.

7. The poultry cage door assembly of claim 1, wherein the main lower end and the secondary lower end collectively define an axis of rotation.

8. The poultry cage door assembly of claim 1, further comprising a first fastener disposed within the main body and the first secondary body.

9. The poultry cage door assembly of claim 1, further comprising a second secondary body having a second secondary lateral end including a secondary keyed arrangement, the main body including a main second lateral end opposite the main first lateral end, the main second lateral end including a third keyed arrangement configured to mate with the secondary keyed arrangement of the second secondary lateral end.

10. The poultry cage door assembly of claim 9, further comprising a second bracket, wherein the second secondary lateral end of the second secondary body further includes a third bracket-receiving feature configured to receive the second bracket.

11. A poultry cage door assembly comprising:
a main body extending from a first end to a second end opposite the first end, the first end including a first keyed arrangement and a first bracket-receiving feature, the second end including a second keyed arrangement;
a first secondary body including a third keyed arrangement and a second bracket-receiving feature, the third keyed arrangement configured to mate with one of the first keyed arrangement and the second keyed arrangement; and
a first bracket mateable with the first bracket-receiving feature and the second bracket-receiving feature.

12. The poultry cage door assembly of claim 11, wherein the first keyed arrangement includes a first recess, a second recess, and a first flange, and wherein the second keyed arrangement includes a second flange, a third flange, and a third recess, the first recess configured to receive the second flange, the second recess configured to receive the third flange, and the third recess configured to receive the first flange.

13. The poultry cage door assembly of claim 11, further comprising a reinforcement member, the body including a first channel, the first secondary body including a second channel, the first channel and the second channel configured to receive the reinforcement member.

14. The poultry cage door assembly of claim 11, further comprising a first fastener and a second fastener, the first fastener disposed within the reinforcement member and the main body, the second fastener disposed within the reinforcement member and the first secondary body.

15. The poultry cage door assembly of claim 11, wherein the first secondary body includes an axle, and wherein the main body includes an axle-receiving feature configured to receive the axle, the axle-receiving feature and the axle collectively defining an axis of rotation of the door assembly.

16. The poultry cage door assembly of claim 15, wherein the axle-receiving feature includes a hub.

17. The poultry cage door assembly of claim 11, wherein the main body and the first secondary body collectively define an axis of rotation.

18. The poultry cage door assembly of claim 11, further comprising a first fastener disposed within the main body and the first secondary body.

19. The poultry cage door assembly of claim 11, further comprising a second secondary body having a fourth keyed arrangement configured to mate with one of the first keyed arrangement and the second keyed arrangement.

20. The poultry cage door assembly of claim 19, further comprising a second bracket, wherein the second secondary body further includes a third bracket-receiving feature configured to receive the second bracket.

21. A poultry cage door main body for attachment with a poultry cage door secondary body having a keyed arrangement, the main body comprising:
a main front side;
a main rear side opposite said main front side;
a main upper end extending from said main front side to said main rear side;
a main lower end opposite said main upper end and extending from said main front side to said main rear side;
a main first lateral end extending from said main front side to said main rear side and from the main upper end to said main lower end, said main first lateral end including a first bracket-receiving feature and a first keyed arrangement, said first keyed arrangement adapted to receive the keyed arrangement of the poultry cage door secondary body.

22. The poultry cage door main body of claim 21, wherein said first keyed arrangement is coupled to the keyed arrangement of the poultry cage door secondary body.
